(19) United States
(12) Patent Application Publication
(10) Pub. No.: US 2003/0011884 A1
(43) Pub. Date: Jan. 16, 2003

(54) Colour autostereoscopic display apparatus

(75) Inventor: Cornelis Van Berkel, Hove (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/191,425

(22) Filed: Jul. 9, 2002

(30) Foreign Application Priority Data
Jul. 11, 2001 (GB) 0116873.1
Sep. 12, 2001 (GB) 0121991.4

(51) Int. Cl. G09G 5/00

(52) U.S. Cl. 359/464; 348/60; 345/6

(57) ABSTRACT

A color display apparatus comprises autostereoscopic display means (10) for displaying a stereoscopic image, for example, an LC matrix display (11) having a row and column array of display elements (12) and parallel lenticular elements (16) overlying the display elements. Diffusing means (40, 80) is selectively operable with the display means to enable a two dimensional image to be perceived. The reduction in horizontal resolution experienced with such multi-view apparatus is at least partially recovered by the diffusing means.

The present invention relates to colour autostereoscopic display apparatus, and more particularly colour autostereoscopic display apparatus comprising autostereoscopic display means for displaying a stereoscopic image and converting means which is selectively operable with said display means such that in a first condition the apparatus displays a stereoscopic image and in a second condition said converting means optically succeeds said display means enabling a two dimensional image to be perceived.

A stereoscopic image is one that can be viewed in three dimensions. An object displayed in this way can be perceived to possess depth when viewed from varying angles. It may be necessary for the viewer to wear special glasses in order to view the image in three dimensions. An autostereoscopic display is one in which special glasses are not required.

Typically, autostereoscopic displays comprise a matrix liquid crystal display (LCD) panel comprising an array of display elements arranged in horizontal rows and vertical columns. The display elements are used to modulate light directed therethrough from a light source. This can be done by applying controllable electric fields across the individual display elements and thus forming an image on the overall array.

Display elements, or sub-pixels, can be grouped together where each sub-pixel in the group modulates light of a different colour. This can be done with the addition of respective colour filters. In this way, colour images can be built up. Each group of sub-pixels forms a pixel. Typically, three different colours are used, each pixel comprising three sub-pixels grouped together as a colour-triplet. The sub-pixels within a triplet can be arranged in a variety of ways. A common example of such an arrangement is where the sub-pixels are positioned contiguously in the horizontal row direction. Colour LCDs, as described above, are well known in the art and are used in many different display applications, for example computer display screens for presenting information in two dimensional form.

Autostereoscopic display apparatus, known in the art, further comprise means for directing the output light from the array of display elements such that the image viewed at a given point on the display panel is dependent on the viewing angle. The right eye of the viewer will see a different view to that seen by the left eye. In this way, the perception of depth within the display is achieved.

It is well known to use a lenticular sheet overlying the display panel to achieve the autostereoscopic effect described above. Examples of such autostereoscopic display apparatus are described in the paper by C. van Berkel et al entitled “Multiview 3D-LCD” published in SPIE Proceedings Vol. 2653,1996, pages 32 to 39, in GB-A-2196166 and in U.S. Pat. No. 6,064,424 in which examples of sub-pixel arrangements are also described. A lenticular sheet, for example in the form of a moulded or machined sheet of polymer material, overlies the output side of the display panel with its lenticular elements, comprising (semi) cylindrical lens elements, extending in the column direction with each lenticular element being associated with a respective group of two, or more, adjacent columns of display elements and extending parallel with the display element columns. In an arrangement in which each lenticule is associated with two columns of display elements, the display panel is driven to display a composite image comprising two 2-D sub-images vertically interleaved, with alternate columns of display elements displaying the two images, and the display elements in each column providing a vertical slice of the respective 2-D (sub) image. The lenticular sheet directs these two slices, and corresponding slices from the display element columns associated with the other lenticules, to the left and right eyes respectively of a viewer in front of the sheet so that, with the sub-images having appropriate binocular disparity, the viewer perceives a single stereoscopic image. In other, multi-view, arrangements, in which each lenticule is associated with a group of more than two adjacent display elements in the row direction and corresponding columns of display elements in each group are arranged appropriately to provide a vertical slice from a respective 2-D (sub-) image, then as a viewer's head moves a series of successive, different, stereoscopic views are perceived for creating, for example, a look-around impression. In view of the need for the lenticular elements to be accurately aligned with the display pixels, it is customary for the lenticular screen to be mounted over the display panel in a permanent manner so that the position of the lenticular elements is fixed in relation to the array of pixels.

Autostereoscopic display apparatus of this kind can be used for various applications, for example in medical imaging, virtual reality, games and CAD fields.

A known disadvantage with the above described autostereoscopic display is that the resulting stereoscopic image suffers a reduced resolution in the horizontal row direction. This is due to the pairing (or grouping) of adjacent columns of display elements. As a result, small font text displayed on a 3-D autostereoscopic display can be difficult to interpret. To alleviate this problem, a display that is convertible between a 2-D and a 3-D mode can be used. It is known to implement a converting means to change the apparatus between a 3-D display mode and a 2-D display mode.

U.S. Pat. No. 5500765 discloses such a convertible 2-D/3-D autostereoscopic display for a convex lenticular lens based autostereoscopic display as described above. A lens sheet is positioned over and in direct contact with the lenticular sheet such that the optical directional action caused by the lenticular sheet is cancelled out and thus a 2-D image can be perceived. One problem associated with such a display is the requirement that the lens sheet must be accurately aligned and in intimate contact with the lenticular elements in order for it to be effective. A complementary alignment structure is needed in order to ensure that the apparatus works effectively and this adds cost to the manufacture of the apparatus. Because it is removable, a further problem is that dust particles, and the like, can become lodged between the two mating surfaces thus preventing them from mating closely and consequently impairing the desired image.

It is an object of the invention to provide an improved colour autostereoscopic display apparatus comprising autostereoscopic display means.

It is another object of the present invention to provide a colour autostereoscopic display apparatus which is capable of being operated to provide selectively to a viewer 3D and 2D images.

According to one aspect of the present invention, there is provided a colour display apparatus of the kind described in the opening paragraph wherein the converting means in the second condition comprises diffusing means. By providing diffusing means such that it optically succeeds the autostereoscopic display means a two dimensional image can be perceived by a viewer. In effect, the converting means can be changed between two conditions such that the colour autostereoscopic display apparatus is capable of operating in a 3-D mode or a 2-D mode respectively. In one setting, the 3-D mode, the converting means is arranged to allow the light output from the autostereoscopic means to pass to a viewer substantially unaltered such that a stereoscopic image may be perceived. In the other setting, the 2-D mode, the converting means comprises diffusing means located in front of the autostereoscopic display means so that the pixels previously visible only to left and right eyes individually are now mixed allowing the same display information to be received by both eyes of that viewer. Thus, the apparatus can be used for colour 3-D stereoscopic displays and 2-D displays of higher resolution merely by selectively operating the converting means between a first and a second condition. Alignment of the diffusing means relative to the autostereoscopic display means is not critical, unlike the aforementioned display apparatus in which accurate alignment is essential. The invention thus offers the significant advantage of enabling the easy operation, by a user, of the colour display apparatus without the need for accurate alignment of the converting means where the same apparatus is used for both high resolution 2-D and 3-D display purposes. When used as, for example, a colour computer display screen, a user can simply selectively operate the converting means so as to switch between the 3-D display mode for stereoscopic images and the increased resolution 2-D display mode for text processing or the like as and when required. According to another aspect of the present invention, there is provided colour autostereoscopic display apparatus comprising autostereoscopic display means for displaying a stereoscopic image comprising a matrix display panel for producing a display at its output side and having an array of display elements, and directing means for directing the outputs from respective groups of display elements in mutually different directions and diffusing means overlying the output side of the matrix display panel for converting the stereoscopic image to a 2-D image.

In a preferred embodiment of the invention, the autostereoscopic display means comprises a matrix display panel, preferably a liquid crystal (LC) matrix display panel having a row and column array of display elements. The rows of display elements are addressed in sequence with video data to build up an image on the array of display elements. Adjacent display elements are preferably grouped together to form pixels. Each display element, or sub-pixel, within a pixel preferably transmits light of a respective, different, colour and thus a colour image can be displayed on the panel. In the case of an LC matrix display panel, for example, a colour display is normally achieved by means of an array of red, green and blue, filters overlying and aligned with the array of display elements. Typically, the colour filters are arranged as strips extending parallel to the display element columns so that three adjacent columns of display elements are associated with red, green and blue filters respectively, the pattern being repeated across the array so that every third column displays the same colour, for example, red.

Although the matrix display panel preferably comprises an LCD panel, it is envisaged that other kinds of display panels could be used, for example electroluminescent or gas plasma display panels. Likewise, although it is preferred that the sub-pixels within the pixel are aligned contiguously in the row direction, it is envisaged that other arrangements could be used, for example a so-called “delta” configuration, as described in the aforementioned U.S. Pat. No. 6,064,424.

The invention allows the use of a conventional form of colour LC matrix display panel, having regularly spaced, aligned, rows and columns of display elements, to be used. In particular, changes to the display element layout are not required.

Preferably, the autostereoscopic display means further comprises an array of elongate lenticular elements extending parallel to one another overlying the matrix display panel. This array is preferably disposed over the output side of the matrix display panel. Each lenticular element is associated with two or more columns of display elements in order to direct the output light in such a way so that a stereoscopic image may be perceived. Alternatively, the lenticular elements can be slanted with respect to the columns as also described in U.S. Pat. No. 6,064,424.

Although the autostereoscopic display means preferably comprises an array of elongate lenticular elements, it is envisaged that other means known in the art for producing the stereoscopic effect could be implemented, for example a parallax barrier.

In one preferred embodiment, the diffusing means preferably comprises a diffusing sheet selectably moveable to a position overlying the autostereoscopic display means and for this purpose may, for example, be pivotally mounted near the periphery of the matrix display panel. The display apparatus can then be changed from a 3-D mode to a 2-D mode simply by positioning the diffusing sheet in front of the display panel. An important advantage of the invention is that the diffusing sheet can merely be located in front of the display panel without the need for accurate alignment within a plane parallel to the display panel unlike the arrangement of U.S. Pat. No. 5,500,765, in which the converting means must be aligned accurately with the row and column array in order to allow 2-D viewing. A further important advantage of the invention is that, ordinarily, the cost of manufacturing a diffusing sheet is significantly less than that of, say, manufacturing a lens sheet custom-made for a particular display panel as in U.S. Pat. No. 5,500,765. Moreover, a user wishing to replace a damaged diffusing sheet will find it easier, quicker and cheaper than replacing a lens sheet.

Although the diffusing means is preferably positioned in front of the display panel when in the 2-D display mode, it is envisaged that it can be located between, and in close proximity to, the display panel and the directing means.

In another preferred embodiment of the colour autostereoscopic display apparatus, the diffusing means comprises an electrically switchable light diffusing layer device. This is positioned in front of the array of display elements. An example of such a device comprises droplets of LC encapsulated within a polymer matrix layer and is commonly referred to as a polymer dispersed liquid crystal (PDLC) device. Examples of PDLC devices are described in EP 0088126. By varying an electric potential applied across the layer such that it changes from transparent to diffusing or vice-versa, the colour display apparatus conveniently can be switched from a 3-D mode to a 2-D mode respectively without the need to remove the layer from the panel.

A further advantage of this embodiment is that the diffusing means can be permanently mounted over the display panel so as to keep the boundary between the two surfaces clear of dust particles.

The switchable layer, as described above, may be arranged to be switched between the two modes as a whole. Alternatively, it may be switched in part only, such that a higher resolution 2-D display is obtained for example from one half of the display area, or in discrete portions of its area which constitute individually switchable windows enabling 3-D and 2-D displays to be provided simultaneously on one display panel. This can be achieved simply by providing separate electrodes whose areas define, for example, the windows to which the electrical potentials for switching can be applied individually and selectively.

In still another embodiment the autostereoscopic display means comprises an array of elongate lenticular elements overlying the display panel, as hereinbefore described, wherein the lenticular array comprises an electrically switchable light diffusing layer. This is preferably switched in the same manner as the PDLC device described above and thus switching between 2-D and 3-D display modes.

Embodiments of colour autostereoscopic display apparatus in accordance with the invention will now be described, by way of example, with reference to the accompanying drawings, in which:

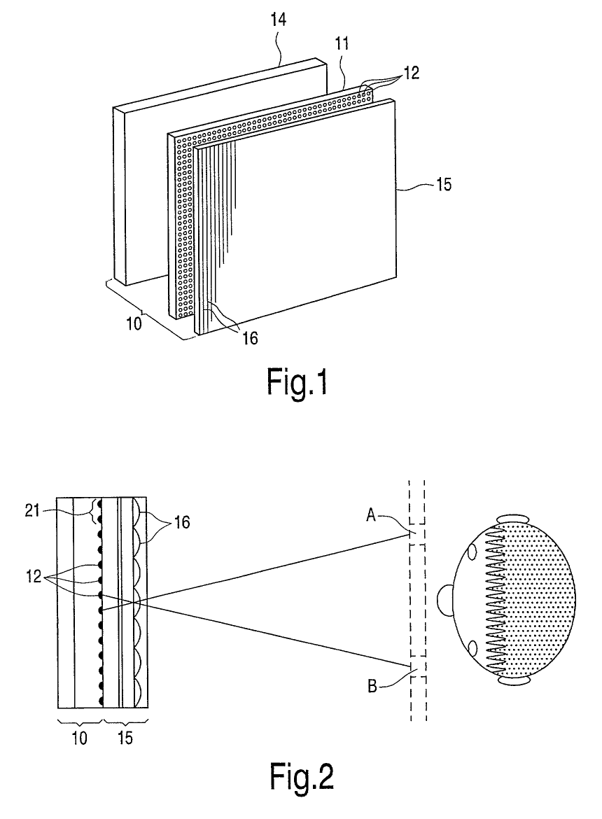

FIG. 1 is a schematic perspective view of a known form of autostereoscopic display means including an array of elongate lenticular elements;

FIG. 2 is a plan schematic view of part of the autostereoscopic display means of FIG. 1 illustrating how two views are provided;

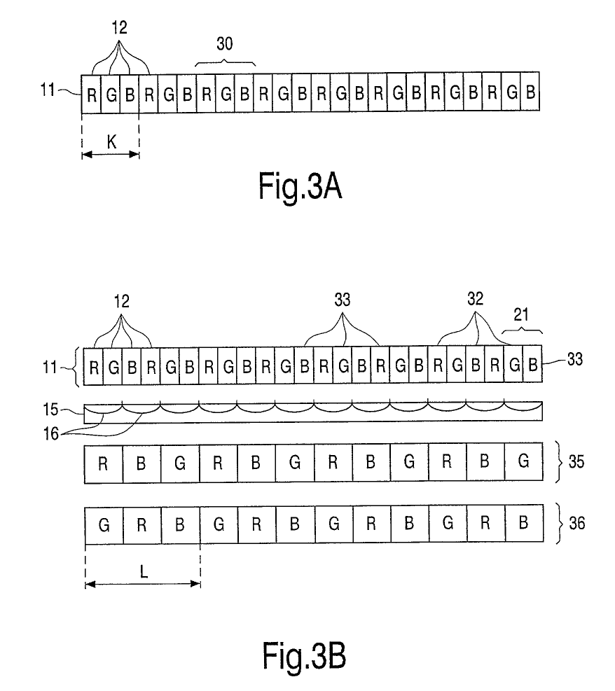

FIGS. 3A and 3B are schematic plan views of part of the array of display elements in the autostereoscopic display means of FIG. 1 illustrating the reduction in resolution when employing, for example, a two view system as shown in FIG. 2;

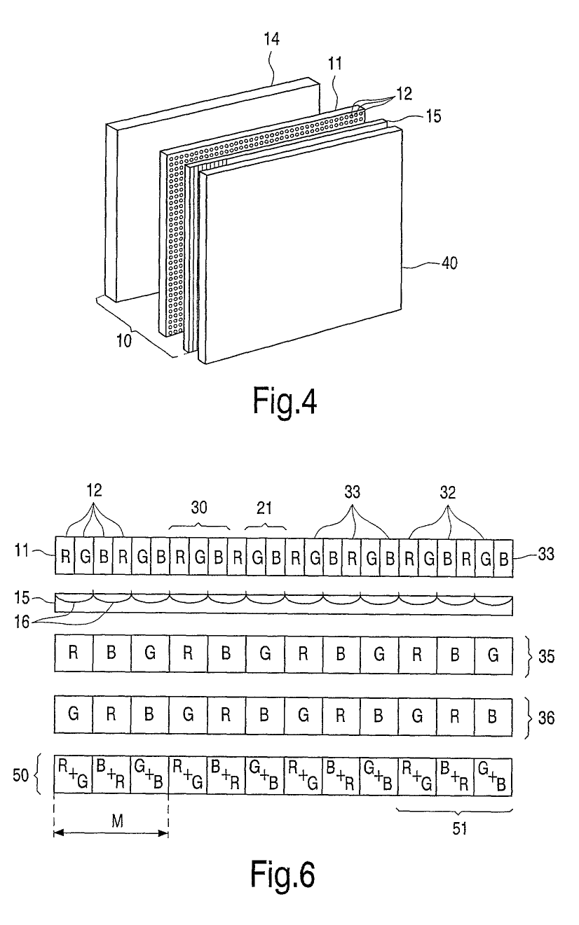

FIG. 4 is a schematic perspective view of an embodiment of colour autostereoscopic display apparatus according to the invention;

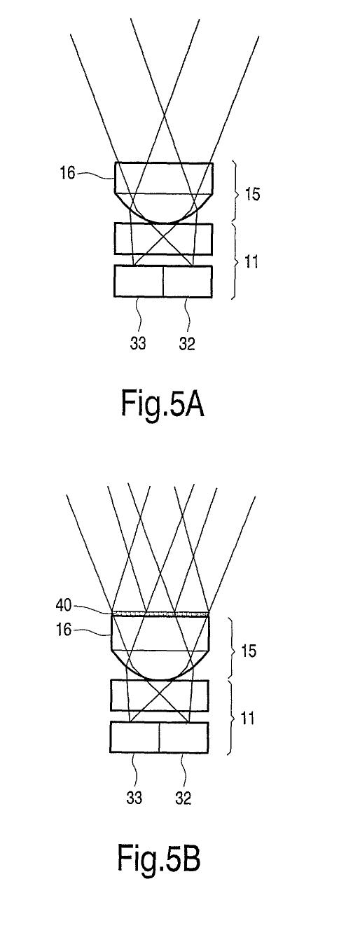

FIGS. 5A and 5B show schematically the effect of diffusing means on the directionality of the output light;

FIG. 6 is a schematic plan view of part of the array of display elements illustrating the recovery of resolution according to the present invention;

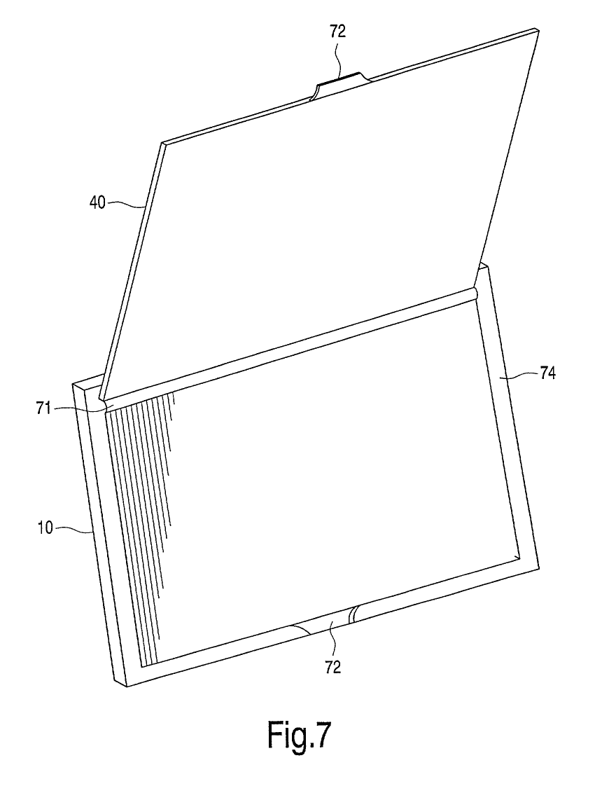

FIG. 7 is a schematic perspective view of another embodiment of the invention using a pivotally mounted diffusing means;

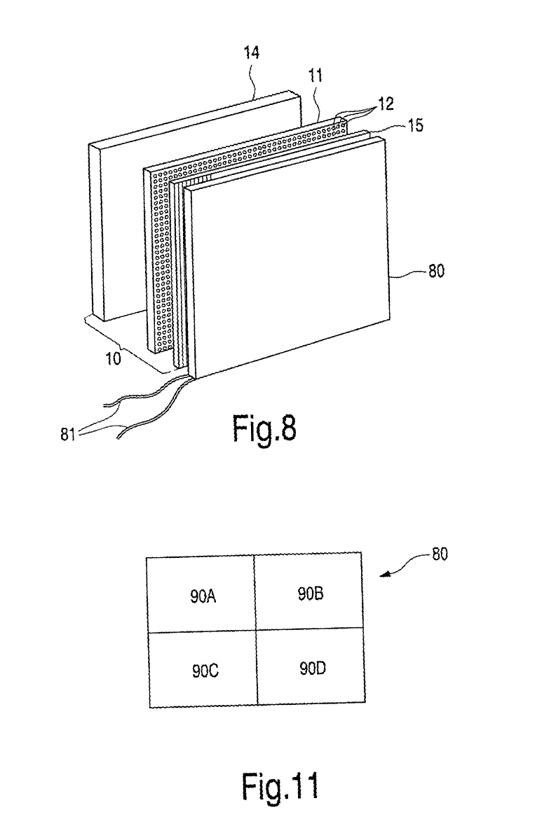

FIG. 8 is a schematic perspective view of still another embodiment of the invention using an electrically switchable light diffusing layer;

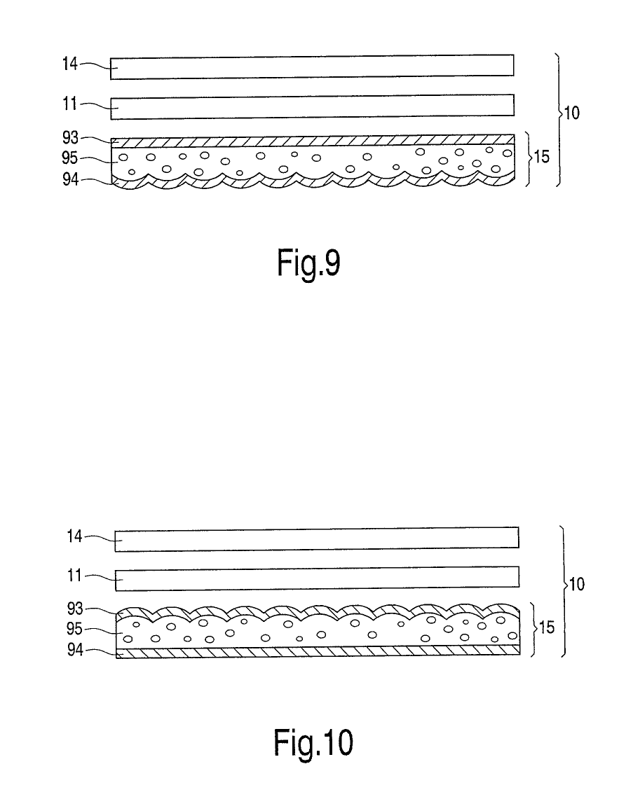

FIG. 9 is a schematic cross-sectional view showing another embodiment using a lenticular array comprising an electrically switchable light diffusing layer;

FIG. 10 is a schematic cross-sectional view showing yet another embodiment using a lenticular array comprising an electrically switchable light diffusing layer; and,

FIG. 11 illustrates a modified form of the electrically switchable light diffusing layer.

It should be understood that the Figures are merely schematic and are not drawn to scale. In particular, certain dimensions have been exaggerated whilst others have been reduced. The same reference numerals are used throughout the drawings to indicate the same or similar parts.

FIG. 1 shows schematically a known form of colour autostereoscopic display means, 10, and the general construction and operating principles of such a display means will first be discussed with reference also to FIGS. 2 and 3. The autostereoscopic display 10 comprises a conventional active colour matrix liquid crystal display (AMLCD) panel 11 used as a spatial light modulator and having a planar array of display elements 12 arranged in aligned rows and columns perpendicular to one another. The display elements are shown schematically with only a comparatively few in each row and column for simplicity. The display panel 11 is illuminated by a light source 14 which can be of any suitable kind and in this example comprises a planar back-light co-extensive with the area of the display element array. Light incident on the panel is modulated by the individual display elements, or sub-pixels, 12 by the application of appropriate drive voltages thereto so as to produce the desired image display output.

Overlying the output side of the display panel 11, there is disposed a lenticular sheet 15 providing an array of elongate, parallel, lenticular elements 16. The lenticular elements 16 comprise optically cylindrically converging lenticules, for example formed as convex cylindrical lenses which extend parallel to the columns of display elements and serve in a known manner to provide separate images, which are generated in the array of the display panel 11 in a vertically interleaved fashion, to the two eyes of a viewer facing the side of the lenticular sheet 15 remote from the display panel 11 so that a stereoscopic, or 3-D, image can be perceived. Autostereoscopic display apparatus using lenticular sheets in conjunction with matrix display panels are well known and it is not thought necessary to describe here in detail their operation. Examples of such apparatus and their operation are described in the aforementioned papers by C. van Berkel et al and in GB-A-2196166 to which reference is invited and whose contents are incorporated herein by reference. Each lenticular element 16 may overlie a respective group of two, three, or more, adjacent columns of sub-pixels, to provide a corresponding number of views. Each lenticular element provides a spatially discrete output beam from each of the associated pixel columns in mutually different, angular directions. The display panel is driven so that a narrow vertical slice of a 2-D (sub) image is produced by each column of sub-pixels with the display produced comprising a plurality of interleaved 2-D (sub) images which are to be seen by the left and right eye respectively of a viewer. Each lenticular element 16 thus provides a plurality of output beams, one from each of its associated columns of sub-pixels, whose optical axes are in mutually different directions and angularly spread around the longitudinal axis of the lenticular element. With appropriate 2-D image information applied to respective columns of display elements then to a viewer whose eyes receive different ones of the beams a 3-D image is perceived. With each lenticular element being associated with a plurality of several sub-pixel columns then different stereoscopic images can be viewed as the viewer's head moves in the row direction. Although the lenticular elements are usually substantially aligned with the sub-pixel columns, they could instead be slanted slightly with respect to the columns as described in U.S. Pat. No. 6,064,424.

FIG. 2 illustrates, in plan view, the operation of the apparatus in producing, in this example, a two view display output, in which each lenticular element 16 overlies a respective group 21, a pair in this example, of adjacent sub-pixel columns such that two vertical strips, each representing a vertical slice of a respective 2-D view, are presented to the viewer. With appropriate 2-D image information applied to the sub-pixels 12, and with the viewer's eyes being at a suitable distance to receive different ones of the output beams, a 3-D image is perceived. The number of views can be varied from just having the two views, shown in FIG. 2, giving a single stereoscopic image to more views, for example seven views providing six stereoscopic images.

FIG. 3 is a schematic plan view of part of a row of display elements in the colour matrix AMLCD panel 11. The panel 11 comprises a colour pixel layout in which each colour pixel 30 comprises three (red, R, green, G, and blue, B) adjacent sub-pixels 12 in a row constituting a horizontal RGB triplet 30. Such a colour pixel layout is formed using vertical colour filter strips with the display elements 12 of the display panel 11 being arranged in respective, R, G and B, columns in repeating fashion. The pixel pitch of such a display panel is a measure of the spacing of the pixels in the panel. Commonly, for a conventional colour matrix LCD panel, the pixel pitch is substantially equal in the vertical, column, and horizontal, row, directions. FIG. 3A shows eight RGB colour pixels 30 each comprising three sub-pixels 12. The horizontal pitch K is equal to the width of the pixel plus the spacing between adjacent pixels (not shown). The resolution of such a display panel 11 is a measure of the spatial frequency at which the pixels are perceived by a viewer. A high resolution is, of course, desirable as this produces a high quality image output. Commonly, for a conventional colour matrix LCD panel, the resolution is substantially equal in the vertical, column, and horizontal, row directions.

FIG. 3B shows the same eight RGB colour pixels as in FIG. 3A. The lenticular array 15 overlies the display panel 11 with each elongate lenticular element 16 substantially covering a respective pair 21 of adjacent sub-pixel columns. It will be appreciated that only one row of the display panel 11 is shown and therefore only one pair of sub-pixels 21 adjacent in the horizontal direction are shown to correspond with each lenticular element 16. It will also be appreciated that the lenticular array 15 is depicted schematically and so a cross-section of part of one row is shown. The individual lenticules 15 direct the output light from the corresponding sub-pixels 32, 33 in mutually different directions. Referring also to FIG. 2, a viewer will perceive a two-view stereoscopic image. The output from each sub-pixel on the left 32 of each pair 21 is directed to region A and therefore is viewed by the right eye of the viewer in FIG. 2. The perceived horizontal pixel pitch L of the image seen at A, 35, is twice the length of the panel horizontal pixel pitch K. Likewise, the output from each sub-pixel on the right 33 of each pair 21 is directed to region B and therefore is viewed by the left eye of the viewer in FIG. 2. The image seen at B, 36, is perceived to have horizontal pixel pitch L. Therefore the horizontal resolution of the two-view stereoscopic image is half of that of the corresponding 2-D image as viewed without the lenticular sheet 15.

Although the example above describes the case for a two-view system, there is also a reduction in resolution with a stereoscopic image having more than two-views. For example, each lenticule may substantially cover four adjacent sub-pixel columns giving a four-view stereoscopic display having a horizontal resolution of one quarter of the corresponding 2-D display.

FIG. 4 is a schematic perspective view of a first embodiment of colour autostereoscopic display apparatus according to the invention comprising diffusing means which in this embodiment optically succeeds the lenticular array. The apparatus comprises an autostereoscopic display means 10 as described hereinbefore with reference to FIG. 1, and a diffusing layer 40, which in this example is selectably mountable on the autostereoscopic display means 10. In a first condition the diffusing layer 40 is removed from the autostereoscopic display means such that a viewer perceives a stereoscopic, 3-D, image. In a second condition the diffusing layer is arranged, as shown in FIG. 4, such that it is in good optical communication with the lenticular sheet and a viewer perceives a 2-D image. The diffusing layer 40 is arranged in close proximity with, preferably directly contacting, the surface of the sheet 15.

FIG. 5A is a schematic plan view illustrating one lenticular element 16 from the lenticular sheet 15 directing the light output from a pair of sub-pixels 32, 33 to create two-views as described in detail above with reference to FIGS. 2 and 3. The outputs from the sub-pixels 32, 33, within the pair 21, are directed in mutually different directions by passing through the lenticular element 16.

In FIG. 5B the optically diffusing layer 40 is disposed over the lenticular element 16 in direct physical contact with a flat surface of the lenticular sheet 15. On exiting the lenticular element the light output from one sub-pixel 32 is diffused such that the directionality of the light is distorted to the extent that the output reaches both eyes of a viewer, thus removing the stereoscopic effect. The same happens with the other sub-pixel 33 within the pair. Therefore the outputs from the pair of sub-pixels 32, 33 are mixed such that a viewer receives the outputs from both sub-pixels in both eyes and thus a 2-D image is perceived.

The effect of the diffusing means is illustrated schematically in FIG. 6 which shows in plan view the row segment of the display panel 11 as in FIG. 3, with overlying lenticular sheet 15 and the respective perceived views 35, 36 of the right and left eyes of a viewer, and with a diffusing layer 40 located between the lenticular sheet and the viewer as shown in FIG. 5B. An averaging effect occurs such that the light outputs from each sub-pixel in each pair 21 are directed in substantially the same directions. Therefore both eyes of a viewer see the same image 50. The output from each perceived pixel corresponding to an individual lenticular element 16 is contributed to by all of the sub-elements within the corresponding, underlying sub-pixel pair 21. For example, where initially without the diffusing layer, the right eye views the output from a red sub-pixel and the left eye views the output from an adjacent green sub-pixel, both eyes now, with the diffusing layer 40 in place, view a mix of the outputs from both the red and green sub-pixels. Therefore a viewer sees an image 50 in which both eyes receive light outputs from all sub-pixels and so a 2-D image is perceived. In this example, a mixed triplet 51 is contributed to by outputs of six display elements, two of each colour. The pitch M of the mixed triplet 51 is the same as the stereoscopic perceived horizontal pitch L. However, the overall output of each mixed triplet 51 comprises the outputs of two colour “unmixed” pixel triplets. Therefore the 2-D perceived horizontal pixel pitch is half of the mixed triplet pitch M. The resolution of the 2-D image is thus greater than the resolution of the stereoscopic image. For a two view display as described in the above example, the full resolution is recovered by using a diffusing layer in this manner.

Due to the uniform nature of the diffusing layer there is no need for it to be accurately aligned with the autostereoscopic display means in a plane parallel to that of the display panel.

Further preferred embodiments of colour display apparatus according to the invention will now be described with reference to FIGS. 7 to 11.

FIG. 7 is a schematic perspective view of a second embodiment of colour display apparatus according to the invention comprising an autostereoscopic display means 10 and a diffusing layer 40, here provided in the form of a plastic sheet or the like, pivotally mounted on the autostereoscopic display means 10 so as to be moveable between a position overlying the display panel 11 and the lenticular sheet 15 and a position away from the display panel by hinging means 71 engaging with a frame part 74 of the display means surrounding the display panel. The diffusing layer therefore can be positioned in front of the display means such that it is substantially parallel to the display panel and in close proximity, preferably contacting, the outermost surface of the display means 10. The apparatus includes latching means 72 enabling the diffusing sheet to be secured in this position and further latching means (not shown) for holding the sheet away from the front when not being used. An advantage of such an apparatus is that the autostereoscopic display 10 and diffusing layer 40 are fixed together. By attaching the diffusing layer to the autostereoscopic display in such a way it can simply be folded for easy storage.

In another embodiment (not shown) the diffusing layer is slidably mounted to the autostereoscopic display means with the aid of channels defined in the frame part 74 at opposing sides enabling the diffusing sheet to be slid in front of the display means such that a 2-D image is perceived. In this case, the sheet may simply be removed from the display means when its use is not required.

In still another embodiment (not shown) the diffusing layer is slidably mounted to the autostereoscopic display means wherein the diffusing sheet can be slid in between the display panel and the directing means such that a 2-D image is perceived.

In yet still a further embodiment (not shown) of the present invention the diffusing layer is formed as a flexible sheet which is carried on a roller extending along one side of the display panel and operable in the manner of a roller blind so as to be unrolled over the display means when required and rolled away when displaying a stereoscopic image. The roller with the sheet may be detachable from the autostereoscopic display means for easy storage when not in use.

FIG. 8 is a schematic perspective view of yet another embodiment of colour display apparatus according to the invention comprising an autostereoscopic display means 10 and an electrically switchable light diffusing layer 80 comprising electro-optic material sandwiched between opposing electrodes and located in front of the display means. By applying appropriate potential differences to the electrodes via leads 81, the layer 80 can be changed optically from a non-scattering state to a strongly diffusing state such that the apparatus changes from a 3-D mode, where a stereoscopic image is displayed, to a 2-D mode, where a two dimensional image is perceived. The electrically switchable light diffusing layer is preferably a Polymer Dispersed Liquid Crystal (PDLC) layer. These are well known in the art and are commercially available. Preferably, the switchable layer is permanently mounted in front of the autostereoscopic display means 10. Therefore the apparatus can be switched from a 3-D mode to a 2-D mode, and vice versa, by simply switching an applied voltage on and off. By using a switchable layer 80 that is sealed to the display means 10, dust particles are less likely to become trapped between the display and the converting means thus keeping the mating surfaces in good optical communication.

Although it is preferable that the electrically switchable light diffusing layer 80 is positioned in front of the directing means 15, it is envisaged that it can be positioned between the directing means and the display panel 11 such that it mates closely with the input side of the directing means instead.

FIG. 9 illustrates schematically another embodiment of the colour autostereoscopic display apparatus with a lenticular array overlying the display panel. The lenticular array 15 comprises a layer of electrically switchable light diffusing material 95, for example PDLC. The surface adjacent the display panel 11 is substantially flat and is in good optical communication with the panel. The output surface comprises the elongate lenticular elements on its output side. Disposed on each of the surfaces of the lenticular sheet are electrodes 93, 94 made from a transparent conducting material, for example Indium Tin Oxide (ITO). A potential difference is applied to these electrodes to switch between a 2-D display mode and a 3-D display mode.

FIG. 10 illustrates another embodiment comprising a lenticular array with a layer of electrically switchable diffusing material 95 sandwiched between two transparent electrodes 93, 94. However, in this case, the lenticular elements 16 are disposed on the surface adjacent the display panel 11. The output surface is substantially flat. A potential difference is applied to the electrodes to switch between 2-D and 3-D display modes.

The diffusing layer 40 or electrically switchable light diffusing layer 80 of the above embodiments may extend completely over the autostereoscopic display means, as shown in FIGS. 4 and 8, so that the apparatus switches between the 2-D and 3-D modes as a whole. If desired, the display area may be sub-divided into sections such that individual sections may be controlled separately from one another. Accordingly, on a selected part or parts of the display array of the apparatus a 2-D image may be perceived whilst on another a stereoscopic image may be displayed simultaneously. The electrically switchable light diffusing layer 80 may be sub-divided in this way such that only selected part(s) are highly diffusing at any one time.

By way of example, and with reference to FIG. 11 which shows schematically a frontal view of the electrically switchable layer 80, the layer may be divided to define four equal quadrants 90A-90D, together covering the area of the display, which are switchable independently. A pair of electrodes for each section allow a potential difference to be applied to each individual section. The individual regions can be switched either separately or in combination. By switching all four quadrants together, an effect analogous to that using a layer which covers completely the display 10 is achieved.

In summary, therefore, a colour autostereoscopic display apparatus has been disclosed which comprises an autostereoscopic display means, for displaying a stereoscopic image and diffusing means selectably operable with the autostereoscopic display means such that the apparatus can be switched between a 3-D and a 2-D display mode. From reading the present disclosure, other modifications will be apparent to persons skilled in the art. Such modifications may involve other features which are already known in the field of colour display apparatus and component parts thereof and which may be used instead of or in addition to features already described herein.

1. Color autostereoscopic display apparatus comprising:
autostereoscopic display means including a display panel for displaying a stereoscopic image; and,
converting means which is selectively operable with said display means such that in a first condition the apparatus displays a stereoscopic image and in a second condition said converting means optically succeeds said display means enabling a two dimensional image to be perceived,
wherein said converting means in said second condition comprises diffusing means.

2. Colour autostereoscopic display apparatus comprising:
autostereoscopic display means for displaying a stereoscopic image comprising a matrix display panel for producing a display at its output side and having an array of display elements, and optical directing means for directing the outputs from respective groups of display elements in mutually different directions; and
diffusing means overlying the output side of the matrix display panel for converting the stereoscopic image to a two dimensional image.

3. Apparatus according to claim 2 wherein the directing means is positioned over the output side of the matrix display panel and wherein the diffusing means is positioned over the directing means at the side thereof remote from the matrix display panel.

4. Apparatus according to claims 1, 2 or 3 wherein said diffusing means comprises a diffusing layer mounted to said autostereoscopic display means.

5. Apparatus according to claim 4 wherein said diffusing layer is removable.

6. Apparatus according to claim 4 wherein said diffusing layer comprises a diffusing sheet pivotally mounted on said autostereoscopic display means so as to be moveable between an operative position overlying the display panel and an inoperative position away from the display panel.

7. Apparatus according to claim 4 wherein said diffusing layer comprises a diffusing sheet slidably mounted on the autostereoscopic display means between an operative position overlying the display panel and an inoperative position away from the display panel.

8. Apparatus according to claim 4 wherein the diffusing layer comprises a flexible diffusing sheet.

9. Apparatus according to claim 8 wherein said flexible diffusing sheet is rollable away from an operative position overlying the display panel.

10. Apparatus according to any one of claims 1 to 4 wherein said diffusing means comprises an electrically switchable light diffusing layer.

11. Apparatus according to claim 1 wherein said display panel comprises a matrix display panel having an array of display elements arranged in rows and columns.

12. Apparatus according to any preceding claim wherein said autostereoscopic display means includes an array of elongate lenticular elements extending parallel to one another one overlying said display panel.

13. Apparatus according to claim 12 wherein said array of elongate lenticular elements comprises an electrically switchable light diffusing light diffusing layer.
